(19) United States
(12) Patent Application Publication
(10) Pub. No.: US 2002/0010078 A1
(43) Pub. Date: Jan. 24, 2002

(54) Process for preparing supported olefin polymerization catalyst

(75) Inventors: Dusan Jeremic, Calgary (CA); Stephen John Brown, Calgary (CA); Ian McKay, Calgary (CA)

Correspondence Address: Kenneth H. Johnson, P. O. Box 630708, Houston, TX, 77263, US

(73) Assignee: NOVA CHEMICAL (INTERNATIONAL) S.A.

(21) Appl. No.: 09/826,395

(22) Filed: Apr. 4, 2001

Related U.S. Application Data
(63) Continuation of application No. 09/662,096, filed on Sep. 14, 2000.

(30) Foreign Application Priority Data
Feb. 6, 1998 (CA) 2,228,923

(51) Int. Cl. B01J 31/00; B01J 37/00; C08F 4/02; C08F 4/60

(52) U.S. Cl. 502/104; 502/108; 502/124; 502/155

(57) ABSTRACT

A catalyst which is useful in slurry or gas phase olefin polymerizations and which is prepared by depositing a combination of an organometallic complex of a group 4 metal and a so-called ionic activator on a metal oxide support. The organometallic complex is characterized by being unbridged and by having a cyclopentadienyl ligand, a phosphinimine ligand and an activatable ligand. The “ionic activator” (for example, triphenylcarbenium tetrakis (pentafluorophenyl) boron) is co-deposited with the organometallic complex. The metal oxide support is pre-treated with, for example, an aluminum alkyl in an amount which is at least equivalent to the molar concentration of surface hydroxyls on the support.

The catalyst prepared by this process is highly active for ethylene polymerization.

### FIELD OF THE INVENTION

This invention relates to a process to prepare a supported catalyst which is highly active for ethylene polymerization. The catalyst is particularly useful in slurry or gas phase polymerization processes.

### BACKGROUND OF THE INVENTION

The synthesis of supported catalyst components using an organometallic complex having a cyclopentadienyl ligand and a phosphinimine ligand is disclosed in a co-pending and commonly assigned patent application entitled “Supported Phosphinimine-Cp Catalysts” (“Stephan et at”).

The Stephan et al reference teaches the use of two different types of activators, namely methyl alumoxane (“MAO”) or triphenylcarbenium tetrakis (pentafluorophenyl) borate (“[Ph₃C][B(C₆F₅)₄]”) and further teaches that the alumoxane (especially MAO) is highly preferred because of the excellent catalyst activity which MAO provides.

However, as will be appreciated by those skilled in the art, the use of MAO has been associated with reactor continuity problems (particularly reactor fouling) when used in supported form. Accordingly, an active catalyst which utilizes a so-called “ionic activator” would represent a useful addition to the commercial art.

Hlatky and Turner made a very elegant invention relating to the use of “ionic activators” as co-catalysts for bis-cyclopentadienyl type metallocenes (as disclosed in U.S. Pat. Nos. (“USP”) 5,153,157 and 5,198,401). Hlatky et al subsequently discovered that this type of catalyst is useful in supported form, as disclosed in PCT patent application WO 91/09882. The '9882 application teaches at examples 10-15 that the metal oxide support material may be pre-treated with an aluminum alkyl prior to the deposition of the catalyst/co-catalyst. Similar treatment of the support with aluminum alkyl when using an ionic activator is also disclosed in the following literature: U.S. Pat. No. 5,474,962 (Takahashi et al; European Patent Application (“EPO”) 628574 (Inatomi et al); PCT application 97/31038 (Lynch et al; and Polymer Preprints 1996, 37(1), p. 249 (Hlatky and Upton). In an analogous disclosure, PCT application 94/07928 teaches the use of MAO pretreatment of a silica support for a monocyclopentadienyl catalyst which is activated with an ionic activator.

### SUMMARY OF THE INVENTION

The invention provides a process for preparing a supported olefin polymerization catalyst consisting of:

Step (1) reacting a particulate metal oxide support having surface hydroxyl groups with a reactive organometallic agent so as to eliminate substantially all of said surface hydroxyl groups;

Step (2) depositing onto the reaction product from said step (1) a combination of:

(2.1) a catalyst which is an unbridged organometallic complex comprising:

(i) a group 4 metal selected from Ti, Hf, and Zr;

(ii) a cyclopentadienyl-type ligand;

(iii) a phosphinimine ligand; and

(iv) two univalent ligands, and

(2.2) an ionic activator.

### DETAILED DESCRIPTION

The organometallic complex of this invention includes a cyclopentadienyl ligand. As used in this specification the term “cyclopentadienyl” refers to a 5-member carbon ring having delocalized bonding within the ring and typically being bound to the group 4 metal (M) through covalent η⁵ -bonds.

An unsubstituted cyclopentadienyl ligand has a hydrogen bonded to each carbon in the ring. (“Cyclopentadienyl-type” ligands also include hydrogenated and substituted cyclopentadienyls, as discussed in detail later in the specification.)

In more specific terms, the group 4 metal complexes of the present invention (also referred to herein as “group 4 metal complex” or “group 4 OMC”) comprise a complex of the formula:

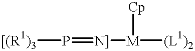

wherein M is selected from the group consisting of Ti, Zr, and Hf; Cp is a cyclopentadienyl-type ligand which is unsubstituted or substituted by up to five substituents independently selected from the group consisting of a C₁₋₁₀ hydrocarbyl radical or two hydrocarbyl radicals taken together may form a ring which hydrocarbyl substituents or cyclopentadienyl radical are unsubstituted or further substituted by a halogen atom, a C₁₋₈ alkyl radical, C₁₋₈ alkoxy radical, a C₆₋₁₀ aryl or aryloxy radical; an amido radical which is unsubstituted or substituted by up to two C₁₋₈ alkyl radicals; a phosphido radical which is unsubstituted or substituted by up to two C₁₋₈ alkyl radicals; silyl radicals of the formula —Si—(R²)₃ wherein each R² is independently selected from the group consisting of hydrogen, a C₁₋₈ alkyl or alkoxy radical, C₆₋₁₀ aryl or aryloxy radicals; germanyl radicals of the formula Ge—(R²)₃ wherein R² is as defined above; each L¹ is independently selected from the group consisting of a hydrogen atom, of a halogen atom, a C₁₋₁₀ hydrocarbyl radical, a C₁₋₁₀ alkoxy radical, a C₅₋₁₀ aryl oxide radical, each of which said hydrocarbyl, alkoxy, and aryl oxide radicals may be unsubstituted by or further substituted by a halogen atom, a C₁₋₈ alkyl radical, C₁₋₈ alkoxy radical, a C₆₋₁₀ aryl or aryloxy radical, an amido radical which is unsubstituted or substituted by up to two C₁₋₈ alkyl radicals; a phosphido radical which is unsubstituted or substituted by up to two C₁₋₈ alkyl radicals, provided that L¹ may not be a Cp radical as defined above.

For reasons of cost, the Cp ligand in the group 4 metal complex is preferably unsubstituted. However, if Cp is substituted, then preferred substituents include a fluorine atom, a chlorine atom, C₁₋₆ hydrocarbyl radical, or two hydrocarbyl radicals taken together may form a bridging ring, an amido radical which is unsubstituted or substituted by up to two C₁₋₄ alkyl radicals, a phosphido radical which is unsubstituted or substituted by up to two C₁₋₄ alkyl radicals, a silyl radical of the formula —Si—(R²)₃ wherein each R ² is independently selected from the group consisting of a hydrogen atom and a C₁₋₄ alkyl radical; a germanyl radical of the formula —Ge—(R²)₃ wherein each R² is independently selected from the group consisting of a hydrogen atom and a C₁₋₄ alkyl radical.

Referring to the above formula, the [(R¹)₃-P═N] fragment is the phosphinimine ligand. The ligand is characterized by (a) having a nitrogen phosphorous double bond; (b) having only one substituent on the N atom (i.e. the P atom is the only substituent on the N atom); and (c) the presence of three substituents on the P atom. Each R¹ is preferably selected from the group consisting of a hydrogen atom, a halide, preferably fluorine or chlorine atom, a C₁₋₄ alkyl radical, a C₁₋₄ alkoxy radical, a silyl radical of the formula —Si—(R²)₃ wherein each R² is independently selected from the group consisting of a hydrogen atom and a C₁₋₄ alkyl radical; and a germanyl radical of the formula —Ge—(R²)₃ or an amido radical of the formula —N—(R²)₂ wherein each R² is independently selected from the group consisting of a hydrogen atom and a C₁₋₄ alkyl radical. It is particularly preferred that each R¹ be a tertiary butyl radical.

The organometallic complex is “unbridged” (which is intended to convey a plain meaning, namely that the phosphinimine ligand is not bonded or bridged to the Cp ligand).

Each L¹ is a univalent ligand. The primary performance criterion for each L¹ is that it doesn't interfere with the activity of the catalyst system. As a general guideline, any of the non-interfering univalent ligands which may be employed in analogous metallocene compounds (e.g. halides, especially chlorine, alkyls, alkoxy groups, amido groups, phosphido groups, etc.) may be used in this invention.

In the group 4 metal complex preferably each L¹ is independently selected from the group consisting of a hydrogen atom, a halogen, preferably fluorine or chlorine atom, a C₁₋₆ alkyl radical, a C₁₋₆ alkoxy radical, and a C₆₋₁₀ aryl oxide radical. For reasons of cost and convenience it is preferred that each L¹ is a halogen (especially chlorine).

The supported catalyst components of this invention are particularly suitable for use in a slurry polymerization process or a gas phase polymerization process.

A typical slurry polymerization process uses total reactor pressures of up to about 50 bars and reactor temperatures of up to about 200° C. The process employs a liquid medium (e.g. an aromatic such as toluene or an alkane such as hexane, propane or isobutane) in which the polymerization takes place. This results in a suspension of solid polymer particles in the medium. Loop reactors are widely used in slurry processes. Detailed descriptions of slurry polymerization processes are widely reported in the open and patent literature.

The gas phase process is preferably undertaken in a stirred bed reactor or a fluidized bed reactor. Fluidized bed reactors are most preferred and are widely described in the literature. A concise description of the process follows.

In general, a fluidized bed gas phase polymerization reactor employs a “bed” of polymer and catalyst which is fluidized by a flow of monomer which is at least partially gaseous. Heat is generated by the enthalpy of polymerization of the monomer flowing through the bed. Unreacted monomer exits the fluidized bed and is contacted with a cooling system to remove this heat. The cooled monomer is then recirculated through the polymerization zone, together with “make-up” monomer to replace that which was polymerized on the previous pass. As will be appreciated by those skilled in the art, the “fluidized” nature of the polymerization bed helps to evenly distribute/mix the heat of reaction and thereby minimize the formation of localized temperature gradients (or “hot spots”). Nonetheless, it is essential that the heat of reaction be properly removed so as to avoid softening or melting of the polymer (and the resultant—and highly undesirable—“reactor chunks”). The obvious way to maintain good mixing and cooling is to have a very high monomer flow through the bed. However, extremely high monomer flow causes undesirable polymer entrainment.

An alternative (and preferable) approach to high monomer flow is the use of an inert condensable fluid which will boil in the fluidized bed (when exposed to the enthalpy of polymerization), then exit the fluidized bed as a gas, then come into contact with a cooling element which condenses the inert fluid. The condensed, cooled fluid is then returned to the polymerization zone and the boiling/condensing cycle is repeated.

The above-described use of a condensable fluid additive in a gas phase polymerization is often referred to by those skilled in the art as “condensed mode operation” and is described in additional detail in U.S. Pat. No. 4,543,399 and U.S. Pat. No. 5,352,749. As noted in the '399 reference, it is permissible to use alkanes such as butane, pentanes or hexanes as the condensable fluid and the amount of such condensed fluid should not exceed about 20 weight per cent of the gas phase.

Other reaction conditions for the polymerization of ethylene which are reported in the '399 reference are:

Preferred Polymerization Temperatures: about 75° C. to about 115° C. (with the lower temperatures being preferred for lower melting copolymers—especially those having densities of less than 0.915 g/cc—and the higher temperatures being preferred for higher density copolymers and homopolymers); and

Pressure: up to about 1000 psi (with a preferred range of from about 100 to 350 psi for olefin polymerization).

The '399 reference teaches that the fluidized bed process is well adapted for the preparation of polyethylene but further notes that other monomers may also be employed. The present invention is similar with respect to choice of monomers.

Preferred monomers include ethylene and C₃₋₁₂ alpha olefins which are unsubstituted or substituted by up to two C₁₋₆ alkyl radicals, C₈₋₁₂ vinyl aromatic monomers which are unsubstituted or substituted by up to two substituents selected from the group consisting of C₁₋₄ alkyl radicals, C₄₋₁₂ straight chained or cyclic diolefins which are unsubstituted or substituted by a C₁₋₄ alkyl radical. Illustrative non-limiting examples of such alpha-olefins are one or more of propylene, 1-butene, 1-pentene, 1-hexene, 1-octene, and 1-decene, styrene, alpha methyl styrene, p- t-butyl styrene, and the constrained-ring cyclic olefins such as cyclobutene, cyclopentene, dicyclopentadiene norbomene, alkyl-substituted norbornenes, alkenyl-substituted norbornenes and the like (e.g. 5-methylene-2-norbornene and 5-ethylidene-2-norbornene, bicyclo-(2,2,1)-hepta-2,5-diene).

The polyethylene polymers which may be prepared in accordance with the present invention typically comprise not less than 60, preferably not less than 70 weight % of ethylene and the balance one or more C₄₋₁₀ alpha olefins, preferably selected from the group consisting of 1 -butene, 1-hexene and 1-octene. The polyethylene prepared in accordance with the present invention may be linear low density polyethylene having a density from about 0.910 to 0.935 g/cc or high density polyethylene having a density above 0.935 g/cc. The present invention might also be useful to prepare polyethylene having a density below 0.910 g/cc—the so-called very low and ultra low density polyethylenes.

The present invention may also be used to prepare co- and terpolymers of ethylene, propylene and optionally one or more diene monomers. Generally, such polymers will contain about 50 to about 75 weight % ethylene, preferably about 50 to 60 weight % ethylene and correspondingly from 50 to 25 weight % of propylene. A portion of the monomers, typically the propylene monomer, may be replaced by a conjugated diolefin. The diolefin may be present in amounts up to 10 weight % of the polymer although typically is present in amounts from about 3 to 5 weight %. The resulting polymer may have a composition comprising from 40 to 75 weight % of ethylene, from 50 to 15 weight % of propylene and up to 10 weight % of a diene monomer to provide 100 weight % of the polymer. Preferred but not limiting examples of the dienes are dicyclopentadiene, 1,4-hexadiene, 5-methylene-2-norbomene, 5-ethylidene-2-norbornene and 5-vinyl-2-norbornene. Particularly preferred dienes are 5-ethylidene-2-norbornene and 1,4-hexadiene.

The present invention unequivocally requires the use of a metal oxide support. An exemplary list of support materials include metal oxides such as silicas, alumina, silica-alumina, alumina-phosphate, titania and zirconia.

These metal oxide support materials initially contain surface hydroxyl groups. Whilst not wishing to be bound by any particular theory, it has been postulated that reactions between the surface hydroxyl and the catalyst and/or ionic activator may “diminish or extinguish catalyst activity” (Ref. Hlatky and Upton, Polymer Preprints 1996, 37(1), 249). Thus, the process of the present invention requires a step in which these surface hydroxyls are treated with a “reactive organometallic agent” so as to substantially eliminate the surface hydroxyls. As used herein, the term “reactive organometallic agent” is meant to describe any organometallic which will react with the surface hydroxyls without producing a subsequent adverse affect upon the activity of the catalyst. Most metal alkyls should satisfy these criteria.

An exemplary list includes aluminum alkyls (particularly the inexpensive and commercially available aluminum alkyls such as triethylaluminum, triisobutyl aluminum and tri n-hexyl aluminum) and magnesium alkyls.

The preferred support material is silica. It will be recognized by those skilled in the art that silica may be characterized by such parameters as particle size, pore volume and initial silanol concentration. The pore size and silanol concentration may be altered by heat treatment or calcining prior to treatment with the reactive organometallic agent.

The preferred particle size, preferred pore volume and preferred residual silanol concentration may be influenced by reactor conditions. Typical silicas are dry powders having a particle size of from 1 to 200 microns (with an average particle size of from 30 to 100 being especially suitable); pore size of from 50 to 500 Angstroms; and pore volumes of from 0.5 to 5.0 cubic centimeters per gram. As a general guideline, the use of commercially available silicas, such as those sold by W. R. Grace under the trademarks Davison 948 or Davison 955, are suitable.

The invention also requires an ionic activator. The ionic activator is an activator capable of ionizing the group 4 metal complex and may be selected from the group consisting of:

(i) compounds of the formula [R⁵]⁺[B(R⁷)₄]⁻ wherein B is a boron atom, R⁵ is a cyclic C₅₋₇ aromatic cation or a triphenyl methyl cation and each R⁷ is independently selected from the group consisting of phenyl radicals which are unsubstituted or substituted with from 3 to 5 substituents selected from the group consisting of a fluorine atom, a C₁₋₄ alkyl or alkoxy radical which is unsubstituted or substituted by a fluorine atom; and a silyl radical of the formula —Si—(R⁹)₃; wherein each R⁹ is independently selected from the group consisting of a hydrogen atom and a C₁₋₄ alkyl radical; and

(ii) compounds of the formula [(R⁸)ₜZH]⁺[B(R⁷)₄]⁻ wherein B is a boron atom, H is a hydrogen atom, Z is a nitrogen atom or phosphorus atom, t is 2 or 3 and R⁸ is selected from the group consisting of C₁₋₈ alkyl radicals, a phenyl radical which is unsubstituted or substituted by up to three C₁₋₄ alkyl radicals, or one R⁸ taken together with the nitrogen atom may form an anilinium radical and R⁷ is as defined above; and

(iii) compounds of the formula B(R⁷)₃ wherein R⁷ is as defined above.

In the above compounds preferably R⁷ is a pentafluorophenyl radical, and R⁵ is a triphenylmethyl cation, Z is a nitrogen atom and R⁸ is a C₁₋₄ alkyl radical or R⁸ taken together with the nitrogen atom forms an anilium radical which is substituted by two C₁₋₄ alkyl radicals.

While not wanting to be bound by theory, it is generally believed that the activator capable of ionizing the group 4 metal complex abstract one or more L¹ ligands so as to ionize the group 4 metal center into a cation (but not to covalently bond with the group 4 metal) and to provide sufficient distance between the ionized group 4 metal and the ionizing activator to permit a polymerizable olefin to enter the resulting active site. In short the activator capable of ionizing the group 4 metal complex maintains the group 4 metal in a +1 valence state, while being sufficiently liable to permit its displacement by an olefin monomer during polymerization. In the catalytically active form, these activators are often referred to by those skilled in the art as substantially non-coordinating anions (“SNCA”).

Examples of compounds capable of ionizing the group 4 metal complex include the following compounds:

triethylammonium tetra(phenyl)boron,

tripropylammonium tetra(phenyl)boron,

tri(n-butyl)ammonium tetra(phenyl)boron,

trimethylammonium tetra(p-tolyl)boron,

trimethylammonium tetra(o-tolyl)boron,

tributylammonium tetra(pentafluorophenyl)boron,

tripropylammonium tetra (o,p-dimethylphenyl)boron,

tributylammonium tetra(m,m-dimethylphenyl)boron,

tributylammonium tetra(p-trifluoromethylphenyl)boron,

tributylammonium tetra(pentafluorophenyl)boron,

tri(n-butyl)ammonium tetra (o-tolyl)boron

N,N-dimethylanilinium tetra(phenyl)boron,

N,N-diethylanilinium tetra(phenyl)boron,

N,N-diethylanilinium tetra(phenyl)n-butylboron,

N,N-2,4,6-pentamethylanilinium tetra(phenyl)boron

di-(isopropyl)ammonium tetra(pentafluorophenyl)boron,

dicyclohexylammonium tetra (phenyl)boron

triphenylphosphonium tetra)phenyl)boron,

tri(methylphenyl)phosphonium tetra(phenyl)boron,

tri(dimethylphenyl)phosphonium tetra(phenyl)boron,

tropillium tetrakispentafluorophenyl borate,

triphenylmethylium tetrakispentafluorophenyl borate,

benzene (diazonium) tetrakispentafluorophenyl borate,

tropillium phenyltris-pentafluorophenyl borate,

triphenylmethylium phenyl-trispentafluorophenyl borate,

benzene (diazonium) phenyltrispentafluorophenyl borate,

tropillium tetrakis (2,3,5,6-tetrafluorophenyl) borate,

triphenylmethylium tetrakis (2,3,5,6-tetrafluorophenyl) borate,

benzene (diazonium) tetrakis (3,4,5-trifluorophenyl) borate,

tropillium tetrakis (3,4,5-trifluorophenyl) borate,

benzene (diazonium) tetrakis (3,4,5-trifluorophenyl) borate,

tropillium tetrakis (1,2,2-trifluoroethenyl) borate,

triphenylmethylium tetrakis (1,2,2-trifluoroethenyl) borate,

benzene (diazonium) tetrakis (1,2,2-trifluoroethenyl) borate,

tropillium tetrakis (2,3,4,5-tetrafluorophenyl) borate,

triphenylmethylium tetrakis (2,3,4,5-tetrafluorophenyl) borate, and

benzene (diazonium) tetrakis (2,3,4,5-tetrafluorophenyl) borate.

Readily commercially available activators which are capable of ionizing the group 4 metal complexes include:

N,N- dimethylaniliumtetrakispentafluorophenyl borate (“[Me₂NHPh][B(C₆F₅)₄]”);

triphenylmethylium tetrakispentafluorophenyl borate (“[Ph₃C][B(C₆F₅)₄]”); and

trispentafluorophenyl boron.

Catalysts prepared by the process of this invention are highly active in the polymerization of ethylene as illustrated in the accompanying examples. High catalyst activity is desirable because it reduces the level of catalyst residue contained in the final product and because it reduces the concentration of transition metal in the polymerization reactor. However, the low concentration of transition metal in the reactor also means that the polymerization process is highly sensitive to trace amounts of impurities. Accordingly, it is preferred to use poison scavengers in the polymerization process when using the catalysts of this invention. The use of an organometallic scavenger (especially an aluminum alkyl) is especially preferred. Moreover, when the catalyst is used in the preferred dichloride form, the organometallic scavenger may also serve as an alkylating agent.

As previously noted, the metal oxide support must be initially treated with the reactive organometallic agent so as to eliminate substantially all of the surface hydroxyls on the support. This initial pretreatment may be conveniently completed by adding a solution of the reactive organometallic agent to the metal oxide support followed by stirring for a sufficient amount of time to allow the organometallic agent to react with the hydroxyls. It will be apparent to those skilled in the art that this is a fairly trivial procedure. As a general guideline, a stirring time of 30 minutes to 10 hours will be sufficient.

The treated support may then be recovered from the slurry by conventional techniques (such as filtration or evaporation of solvent) followed by an optional wash of the treated support to remove any free or excess amount of the reactive organometallic agent.

The catalyst and ionic activator are then co-deposited on the treated support. Again, this is a trivial procedure for a skilled chemist. A preferred method is to first prepare a solution of the catalyst and activator in a hydrocarbon solvent and to then add this solution to the treated support. This results in a slurry which is preferably stirred for from 30 minutes to 8 hours, followed by recovery of the supported catalyst by filtration and/or solvent evaporation. The mole ratio of the ionic activator to the catalyst component is preferably from 0.5/1 to 2/1; most preferably 1/1 (with the basis being the moles of group 4 transition metal in the catalyst to moles of substantially non-coordinating anion provided by the ionic activator).

The catalysts produced by the process of this invention are highly active for ethylene polymerization. This is desirable because it effectively reduces the amount of support material contained in the polyethylene product. It will be appreciated by those skilled in the art that it is desirable for supported catalysts to produce at least 3×10³ grams of polyethylene per gram of support material (otherwise, plastic film which is subsequently produced form the polyethylene may have a gritty and/or sandy appearance and texture). The productivity of a supported catalyst (expressed on a support basis) may be influenced within a certain range by increasing or decreasing the amount of the transition metal catalyst on the support. For example, even if a transition metal catalyst has low activity, it may be possible to produce a commercially useful supported catalyst by increasing the level of transition metal on the support. However, there are limits to this approach due to problems which are associated with obtaining a satisfactory dispersion of the transition metal on the support. In particular, it is preferred to use a transition metal concentration of less than 5 millimoles per gram of support, especially less than 2, and most preferably less than 1.

Further details are illustrated in the following non-limiting examples.

### EXAMPLES

Catalyst Preparation and Polymerization Testing Using a Semi-Batch, Gas Phase Reactor

The catalyst preparation methods described below employ typical techniques for the synthesis and handling of air-sensitive materials. Standard Schlenk and drybox techniques were used in the preparation of ligands, metal complexes, support substrates and supported catalyst systems. Solvents were purchased as anhydrous materials and further treated to remove oxygen and polar impurities by contact with a combination of activated alumina, molecular sieves and copper oxide on silica/alumina.

All the polymerization experiments described below were conducted using a semi-batch, gas phase polymerization reactor of total internal volume of 2.2 liters. Reaction gas mixtures, including separately ethylene or ethylene/butene mixtures were measured to the reactor on a continuous basis using a calibrated thermal mass flow meter, following passage through purification media as described above. A predetermined mass of the catalyst sample was added to the reactor under the flow of the inlet gas. The catalyst was treated in-situ (in the polymerization reactor) at the reaction temperature in the presence of the monomers, using a metal alkyl complex which has been previously added to the reactor to remove adventitious impurities. Purified and rigorously anhydrous sodium chloride was used as a catalyst dispersing agent.

The internal reactor temperature is monitored by a thermocouple in the polymerization medium and can be controlled at the required set point to +/−1.0° C. The duration of the polymerization experiment was one hour. Following the completion of the polymerization experiment, the polymer was separated from the sodium chloride and the yield determined.

Catalyst Preparation

Part 1.1

A commercially available silica support material (sold under the tradename “Davison 955” by W. R. Grace) was mixed with a 35 weight % solution of triisobutyl aluminum (“TIBAL”) in hexane. The TIBAL/silica weight ratio was about 2/1 which provided a large molar excess of the TIBAL to the hydroxyl groups on the silica. The mixture was stirred overnight, followed by recovery of the TIBAL-treated support by filtration and final washing.

Part 1.2

In an inventive experiment, cyclopentadienyl titanium [tri (tertiary butyl) phosphinimine] dichloride (“catalyst”) was mixed with [Me₂NHPh][B(C₆F₅)₄] (“ionic activator”) in toluene (with the catalyst/ionic activator mole ratio being 1/1).

Subsequently, the mixture was added to a toluene slurry of the TIBAL-treated silica support from Part 1.1 (0.1 millimole of titanium per gram of silica). The resulting mixture was heated for 30 minutes at 80° C. with stirring followed by removal of the solvent under vacuum.

Part 1.3 (Comparative)

Metallocene catalysts in which the cyclopentadienyl ligands are substituted with alkyl groups, such as n-butyl, are well known to be highly active (as disclosed in U.S. Pat. No. 5,324,800, “Welborn”). Thus, for the comparative experiment, the procedures described in Part 1.2 above were repeated except that bis [(n-butyl)-cyclopentadienyl] zirconium dichloride was used as the catalyst.

Polymerization

Part 2.1 (Inventive)

The above described 2.2 liter polymerization reactor was initially charged with a 160 g bed of sodium chloride (table salt, as a seed bed) and 0.5 ml of a 25 weight % solution of tri n-hexyl aluminum in hexane and 20 mg of the supported catalyst from Part 1.2 above. Polymerization was undertaken for 1 hour at 90° C. and an ethylene pressure of 200 pounds per square inch gauge. 120 grams of polyethylene was produced, corresponding to a productivity of about 6×10³ g of polyethylene per gram of catalyst per hour. This is substantially in excess of the 3×10³ g of polyethylene per gram of catalyst which is desirable for high quality film resins. In addition, the very high activity corresponds to a residual titanium concentration in the polyethylene of less than 1 part per million by weight.

Part 2.2

In a comparative polymerization experiment using 50 mg of the catalyst from Part 1.3 and 1.0 ml of a 25 weight % solution of tri n-hexyl aluminum in hexane, a catalyst productivity of 1.5×10³ g polyethylene per gram of catalyst per hour was observed (using the same ethylene pressure and temperature as used in Part 2.1). This polyethylene would not be suitable for producing high quality film due to the high concentration of catalyst support material in the resin.

What is claimed is:

1. A process for preparing a supported olefin polymerization catalyst consisting of:
Step (1) reacting a particulate metal oxide support having surface hydroxyl groups with a reactive organometallic agent so as to eliminate substantially all of said surface hydroxyl groups;
Step (2) depositing onto the reaction product from said step (1) a combination of:
(2.1) a catalyst which is an unbridged organometallic complex comprising:
(i) a group 4 metal selected from Ti, Hf, and Zr;
(ii) a cyclopentadienyl-type ligand;
(iii) a phosphinimine ligand; and
(iv) two univalent ligands, and
(2.2) an ionic activator.

2. The process of claim 1 wherein said organometallic complex comprises a complex of the formula: 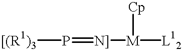
wherein M is selected from the group consisting of Ti, Zr, and Hf; Cp is a cyclopentadienyl-type ligand which is unsubstituted or substituted by up to five substituents independently selected from the group consisting of a C₁₋₁₀ hydrocarbyl radical or two hydrocarbyl radicals taken together may form a ring which hydrocarbyl substituents or cyclopentadienyl radical are unsubstituted or further substituted by a halogen atom, a C₁₋₈ alkyl radical, C₁₋₈ alkoxy radical, a C₆₋₁₀ aryl or aryloxy radical; an amido radical which is unsubstituted or substituted by up to two C₁₋₈ alkyl radicals; a phosphido radical which is unsubstituted or substituted by up to two C₁₋₈ alkyl radicals; silyl radicals of the formula —Si—(R²)₃ wherein each R² is independently selected from the group consisting of hydrogen, a C₁₋₈ alkyl or alkoxy radical, C₆₋₁₀ aryl or aryloxy radicals; germanyl radicals of the formula Ge—(R²)₃ wherein R² is as defined above; each R¹ is independently selected from the group consisting of a hydrogen atom, a halogen atom, C₆₋₁₀ hydrocarbyl radicals which are unsubstituted by or further substituted by a halogen atom, a C₁₋₈ alkyl radical, C₁₋₈ alkoxy radical, a C₆₋₁₀ aryl or aryloxy radical, a silyl radical of the formula —Si—(R²)₃ wherein each R² is independently selected from the group consisting of hydrogen, a C₁₋₈ alkyl or alkoxy radical, C₆₋₁₀ aryl or aryloxy radicals, germanyl radical of the formula Ge—(R²)₃ wherein R² is as defined above or two R¹ radicals taken together may form a bidentate C₁₋₁₀ hydrocarbyl radical, which is unsubstituted by or further substituted by a halogen atom, a C₁₋₈ alkyl radical, C₁₋₈ alkoxy radical, a C₆₋₁₀ aryl or aryloxy radical, a silyl radical of the formula —Si—(R²)₃ wherein each R² is independently selected from the group consisting of hydrogen, a C₁₋₈ alkyl or alkoxy radical, C₆₋₁₀ aryl or aryloxy radicals, germanyl radicals of the formula Ge—(R²)₃ wherein R² is as defined above, provided that R₁ individually or two R₁ radicals taken together may not form a Cp ligand as defined above; each L¹ is independently selected from the group consisting of a hydrogen atom, of a halogen atom, a C₁₋₁₀ hydrocarbyl radical, a C₁₋₁₀ alkoxy radical, a C₅₋₁₀ aryl oxide radical, each of which said hydrocarbyl, alkoxy, and aryl oxide radicals may be unsubstituted by or further substituted by a halogen atom, a C₁₋₈ alkyl radical, C₁₋₈ alkoxy radical, a C₆₋₁₀ aryl or aryloxy radical, an amido radical which is unsubstituted or substituted by up to two C₁₋₈ alkyl radicals; a phosphido radical which is unsubstituted or substituted by up to two C₁₋₈ alkyl radicals, provided that L¹ may not be a Cp radical as defined above.

3. The process of claim 1 wherein said metal oxide support is silica.

4. The process of claim 1 wherein said reactive organometallic agent is selected from the group consisting of alumoxanes and trialkyl aluminum.

5. The process of claim 4 wherein said trialkyl aluminum is selected from triethyl aluminum, triisobutyl aluminum and tri n-hexyl aluminum.

6. The process of claim 1 wherein said univalent ligands is a halogen.

7. The process of claim 6 wherein said halogen is chlorine.

8. The process of claim 2 wherein said group 4 metal is titanium and wherein the concentration of said titanium is less than 1 millimole per gram of said particulate metal oxide support.

9. A process for preparing a supported olefin polymerization catalyst consisting of:
Step (1) reacting a solid particulate inorganic oxide support having surface hydroxyl groups with a reactive organometallic agent so as to reduce the number of said surface hydroxyl groups;
Step (2) depositing onto the reaction product from said step(1) a combination of:
(2.1) a precatalyst which is an unbridged organometallic complex comprising:
(i) a metal selected from Ti, Hf or Zr;
(ii) a cyclopentadienyl radical-containing ligand;
(iii) a phosphinimine ligand; and
(iv) two other univalent ligands, and
(2.2) an ionic precatalyst activator.

10. The process of claim 9 wherein said organometallic complex comprises a complex of the formula: 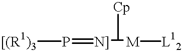
wherein M is selected from the group consisting of Ti, Zr, and Hf; Cp is a cyclopentadienyl radical-containing ligand which is unsubstituted or substituted by up to five substituents independently selected from the group consisting of a C₁₋₁₀ hydrocarbyl radical, or two hydrocarbyl radicals taken together may form a ring, which hydrocarbyl substituents or cyclopentadienyl radical are unsubstituted or further substituted by a halogen atom, a C₁₋₈ alkyl radical, C₁₋₈ alkoxy radical, a C₆₋₁₀ aryl or aryloxy radical; an amido radical which is unsubstituted or substituted by up to two C₁₋₈ alkyl radicals; a phosphido radical which is unsubstituted or substituted by up to two C₁₋₈ alkyl radicals; silyl radicals of the formula —Si—(R²)₃ wherein each R² is independently selected from the group consisting of hydrogen, a C₁₋₈ alkyl or alkoxy radical, C₆₋₁₀ aryl or aryloxy radicals; and germanyl radicals of the formula Ge—(R²)₃ wherein R² is as defined above; each R¹ is independently selected from the group consisting of a hydrogen atom, a halogen atom, C₁₋₁₀ hydrocarbyl radicals which are unsubstituted or further substituted by a halogen atom, a C₁₋₈ alkyl radical, a C₁₋₈ alkoxy radical, a C₆₋₁₀ aryl or aryloxy radical, a silyl radical of the formula —Si—(R²)₃ wherein each R² is as defined above, and germanyl radicals of the formula Ge—(R²)₃ wherein R² is as defined above or two R¹ radicals taken together may form a bidentate C₁₋₁₀ hydrocarbyl radical, which is unsubstituted or further substituted by a halogen atom, a C₁₋₈ alkyl radical, a C₁₋₈ alkoxy radical, a C₆₋₁₀ aryl or aryloxy radical, a silyl radical of the formula —Si—(R²)₃ wherein each R² is as defined above, and germanyl radicals of the formula Ge—(R²)₃ wherein R² is as defined above, provided that R¹ individually or two R¹ radicals taken together may not form a Cp ligand as defined above; each L¹ is independently selected from the group consisting of a hydrogen atom, a halogen atom, a C₁₋₁₀ hydrocarbyl radical, a C₁₋₁₀ alkoxy radical, a C₅₋₁₀ aryl oxide radical, each of which said hydrocarbyl, alkoxy, and aryl oxide radicals may be unsubstituted or further substituted by a halogen atom, a C₁₋₈ alkyl radical, C₁₋₈ alkoxy radical, a C₆₋₁₀ aryl or aryloxy radical, an amido radical which is unsubstituted or substituted by up to two C₁₋₈ alkyl radicals; and a phosphido radical which is unsubstituted or substituted by up to two C₁₋₈ alkyl radicals, provided that L¹ may not be a Cp ligand as defined above.

11. The process of claim 9 wherein said solid particulate inorganic oxide is silica.

12. The process of claim 9 wherein said reactive organometallic agent is selected from the group consisting of alumoxanes and trialkyl aluminum.

13. The process of claim 12 wherein said trialkyl aluminum is selected from the group consisting of triethyl aluminum, triisobutyl aluminum and tri n-hexyl aluminum.

14. The process of claim 9 wherein said two other univalent ligands comprise halogen.

15. The process of claim 14 wherein said halogen is chlorine.

16. The process of claim 10 wherein said metal is titanium and wherein the concentration of said titanium is less than 1 millimole per gram of said solid particulate inorganic oxide.
